(19) United States
(12) Patent Application Publication
(10) Pub. No.: US 2009/0000598 A1
(43) Pub. Date: Jan. 1, 2009

(54) Reciprocating-piston internal combustion engine with variable compression ratio

(76) Inventors: Michael Bach, Marbach am Neckar (DE); Hans-Georg Lehmann, Esslingen (DE); Dieter Nowak, Weilheim (DE); Dietmar Schroer, Remseck (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/152,867

(22) Filed: May 16, 2008

Related U.S. Application Data
(63) Continuation-in-part of application No. PCT/EP2006/010890, filed on Nov. 14, 2006.

(30) Foreign Application Priority Data
Nov. 17, 2005 (DE) 10 2005 054 760.5

(51) Int. Cl. F02B 75/04

(52) U.S. Cl. 123/48 B

(57) ABSTRACT

In a reciprocating-piston internal combustion engine with a piston movably arranged in a cylinder and coupled via a connecting rod to a transverse lever having a center of gravity, the transverse lever which is supported by a crankshaft and connected to an auxiliary connecting rod by an eccentric for adjusting the compression ratio of the internal combustion engine, the transverse lever has a weight and configuration providing for the center of gravity located so that an excellent operating smoothness of the engine is obtained with simple means.

This is a Continuation-In-Part application of pending international patent application PCT/EP2006/010890 filed Nov. 14, 2008 and claiming the priority of German patent application No. 10 2005 054 760.5 filed Nov. 17, 2005.

### BACKGROUND OF THE INVENTION

The invention relates to a reciprocating-piston internal combustion engine with variable compression ratio including a piston which is movably arranged in a cylinder and which is coupled to a connecting rod whose movement can be transmitted to a stroke journal of a crankshaft with a motion transmission element being provided between the connecting rod and the stroke journal.

EP 1 307 642 B1 discloses a reciprocating-piston internal combustion engine with variable compression ratio. Variations in the compression ratio are obtained in that a transverse lever is arranged between a connecting rod, which is connected to a piston, and a crank of a crankshaft. The movement profile of the transverse lever can be manipulated by means of an auxiliary connecting rod which is articulatedly fastened at one side to the transverse lever and whose other end is mounted in a movable fashion by means of an eccentric or a crank. By rotating the eccentric or the crank, the auxiliary connecting rod is moved at its end relative to the engine housing. As a result of the articulated connection to the transverse lever, the latter end position relative to the crank of the crankshaft can be changed so that the general position of the connecting rod and the piston relative to the cylinderhead in the direction of the cylinder can be changed. A variation of the compression ratio of the internal combustion engine therefore takes place.

It is an object of the present invention to refine a reciprocating-piston internal combustion engine with variable compression ratio of said type so as to obtain improved engine operating smoothness.

### SUMMARY OF THE INVENTION

In a reciprocating-piston internal combustion engine with a piston movably arranged in a cylinder and coupled via a connecting rod to a transverse lever, a center of gravity of the transverse lever supported by an eccentric for adjusting the compression ratio of the internal combustion engine, the transverse lever has a weight and configuration with a center of gravity so selected that an excellent operating smoothness of the engine is obtained with simple means.

The reciprocating-piston internal combustion engine with variable compression ratio according to the invention is in a drawing plane divided by two axes into four quadrants I to IV in the mathematically conventional way wherein a first bearing point is arranged in the second quadrant II, and a center of gravity of the transverse lever is arranged in one of the quadrants II, III or IV. In a generic power unit of a reciprocating-piston engine with a transverse lever and an auxiliary connecting rod in addition to the known power unit elements of piston, connecting rod and crankshaft, forces and torques are generated by the oscillating and rotating movement of the individual components. By means of the skilful arrangement both of the centers of rotation and joint points and also of the centers of gravity of the individual elements of the power unit, it is possible for the inertial and centrifugal forces which are generated during the movement of the individual elements to be superposed with one another in such a way that said forces cancel one another out to a large extent.

A displacement of the center of gravity with an advantageous effect is obtained by means of an arrangement in which the center of gravity of the transverse lever is displaced by an additional mass on the transverse lever in one of the quadrants II, III or IV.

The center of gravity can be generated in a particularly simple and cost-effective manner by means of an additional mass on the transverse lever. For this purpose, it is sufficient for the cross section of the transverse lever to be enlarged beyond the dimension required for the strength. This can be obtained without additional screw connections or machining.

By means of the selection according to the invention of the position and magnitude of the center of gravity of the transverse lever in a single-cylinder power unit, a 1^{st} order force which rotates counter to the rotational direction of the crankshaft remains as a resultant force from the moving masses of the power unit. A force of said type can for example be eliminated by means of a balancing mass. All other forces and moments are negligibly small or are cancelled out entirely.

In a reciprocating-piston internal combustion engine of four-cylinder in-line design, it is possible by means of a skilful selection of the dimensions of the elements of the power unit, and by means of a position of the center of gravity of the transverse lever according to the invention, for the 1^{st} and 2^{nd} order mass forces and mass moments of the crank drive to be completely balanced. In a four-cylinder in-line engine with a conventional crank pin arrangement of the crankshaft and ignition sequence, the rotating 1^{st} order forces of each cylinder power unit cancel one another out if the center of gravity of the transverse lever is arranged so as to be displaced according to the invention. Excellent running smoothness is obtained in this way.

Particularly good running smoothness and a good adjustability of the compression of the reciprocating-piston internal combustion engine is obtained if the side length a between the first (connecting rod) bearing point and the second (auxiliary connecting rod) bearing point and the side length b between the second (auxiliary connecting rod) bearing point and the crank joint point and the side length c between the first (connecting rod) bearing point and the crank joint point in relation to the crank radius r are dimensioned as follows:

4.0*r≦a≦7.0*r,

2.2*r≦b≦5.5*r and

1.2*r≦c≦3.5*r.

The crank radius r is defined as the spacing between the rotational axis of the crankshaft and the center of the stroke journal which forms the crank joint point.

The invention will become more readily apparent from the following description of exemplary embodiments of the invention illustrated in simplified form with reference to in the accompanying drawings:

### BRIEF DESCRIPTION OF THE DRAWINGS

FIG. 1 shows a cylinder unit of a reciprocating-piston internal combustion engine according to the invention including a device for adjusting a compression ratio,

FIG. 2 shows a known transverse lever of a known adjusting device for varying a compression ratio, and

FIG. 3 shows a transverse lever according to the invention of an adjusting device for varying a compression ratio.

### DETAILED DESCRIPTION OF THE INVENTION

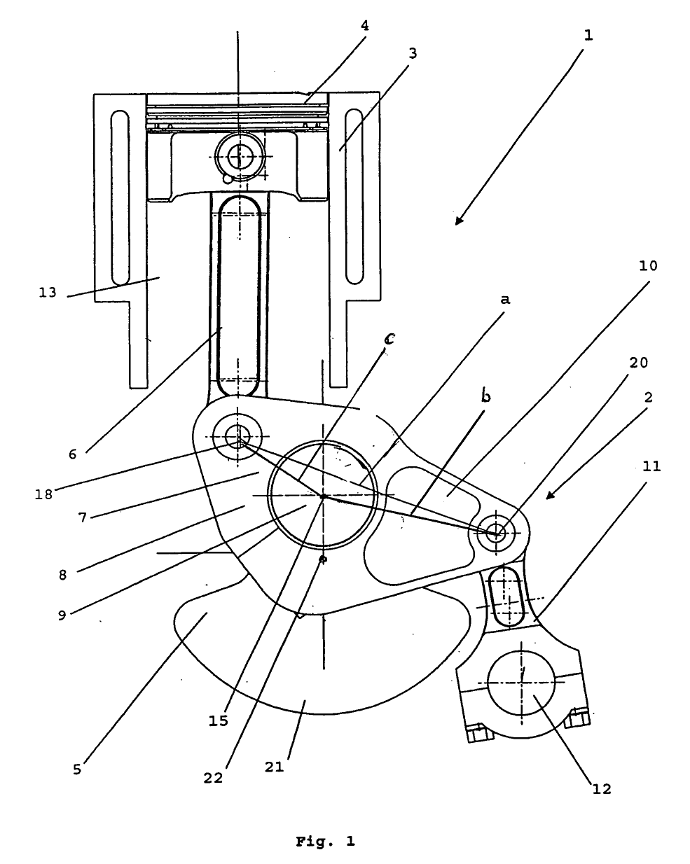

FIG. 1 shows a reciprocating-piston internal combustion engine 1 having an adjusting device 2 for varying a compression ratio. The reciprocating-piston internal combustion engine 1 is composed of a housing 3 in which a piston 4 is mounted in a movable fashion in a cylinder 13, and a crankshaft 5 which rotates in the housing 3 about its rotational axis 22.

The adjusting device 2 for varying the compression ratio is composed primarily of a connecting rod 6 which connects the piston 4 to a first lever arm 7 of a transverse lever 8 which itself is rotatably mounted on a stroke journal 9 of the crankshaft 5. A second lever arm 10 of the transverse lever 8 is connected by means of an auxiliary connecting rod 11 to an eccentric 12 which itself is rotatably mounted in the housing 3.

An adjustment of the compression ratio is initiated by rotating the eccentric 12 which, by means of the auxiliary connecting rod 11, thereby rotates the transverse lever 8 by a few degrees about the stroke journal 9 of the crankshaft 5. As a result of said rotation of the transverse lever 8 about the stroke journal 9, the connecting rod 6 and the piston 4 are moved and the compression ratio of the reciprocating-piston internal combustion engine 1 is varied. The position of the piston 4 is dependent, primarily on the position of the crankshaft 5 with the stroke journal 9 and the lengths and spacings of the connecting rod 6, first lever arm 7 of the transverse lever 8, second lever arm 10, auxiliary connecting rod 11 and eccentric 12, but also on the position of the eccentric 12.

The particular kinematic arrangement of the reciprocating-piston internal combustion engine 1 having the adjusting device 2 leads to an approximation of the stroke function of the piston 4 to a sinusoidal form. Therefore, in a reciprocating-piston internal combustion engine 1 according to the invention with four cylinders 13 in an in-line arrangement, the free 2^{nd} order mass forces in the direction of the cylinder 13 are significantly reduced.

As a result of the movements of the individual components, such as for example the connecting rod 6, auxiliary connecting rod 11 and transverse lever 8, higher-order forces which cannot be balanced are generated in the direction of the cylinder 13 and in the transverse direction thereto. The forces in the transverse direction of the reciprocating-piston internal combustion engine 1 in particular are unfavorable for reasons of comfort in motor vehicles.

The position of the center of gravity 14 of the trans-verse lever 8 is a significant influential variable for the free forces in the power unit and the vibration behavior of the reciprocating-piston internal combustion engine 1.

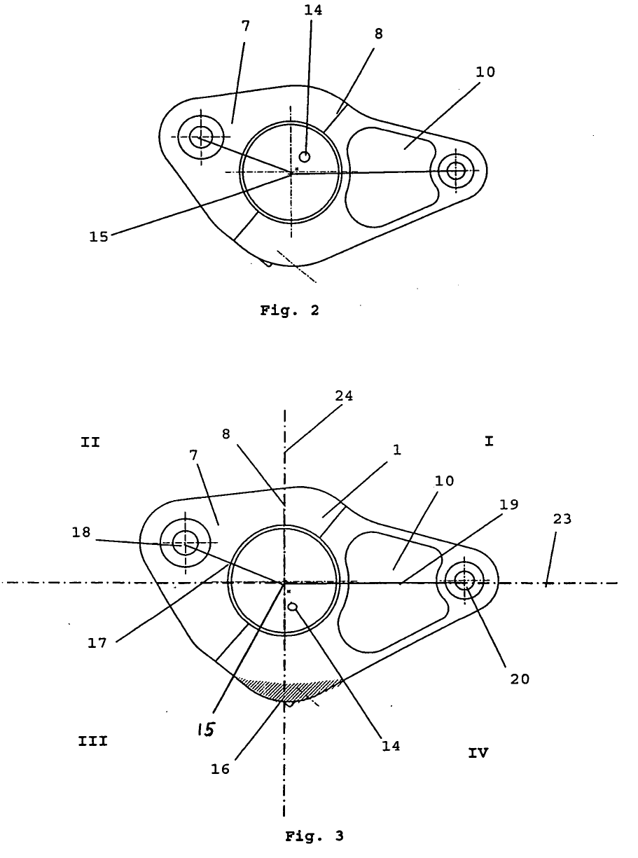

FIG. 2 shows a known transverse lever 8 of a known adjusting device 2 for varying a compression ratio. The transverse lever 8 has a first lever arm 7 and a second lever arm 10 which extend at an angle of less than 180° with respect to one another. The transverse lever 8 is designed in terms of its dimensions for low weight and sufficient strength. The center of gravity 14 of the transverse lever 8 is situated, in FIG. 2, to the right of and above the axis of the joint center point 15 about which the transverse lever 8 rotates about the stroke journal 9 in the installed state. Said position of the center of gravity 14 results from the different lengths of the two lever arms 7, 10 and the non-straight line position with respect to one another.

FIG. 3 shows a transverse lever 8 of an adjusting device 2 for varying a compression ratio of a reciprocating-piston internal combustion engine. The transverse lever 8 is provided with an imaginary orthogonal axis system. The origin of the axis system is arranged at the joint center point 15 of the transverse lever 8. A first axis 23 passes through the origin and a second bearing point 20 on the second lever arm 10 of the transverse lever 8. The second axis 24, which is arranged perpendicular to the first axis 23, likewise passes through the origin and divides the drawing plane into four quadrants I, II, III and IV. The arrangement of the first lever arm 7 and of the second lever arm 10 with respect to one another and relative to the joint center point 15 corresponds to the arrangement known from FIG. 2 in order to permit the function of a variation of the compression. However, the transverse lever 8 according to the invention is provided with an additional mass 16 which displaces the center of gravity 14 of the transverse lever 8 with respect to the position shown in FIG. 2. The center of gravity 14 is situated in quadrant IV in FIG. 3, that is, in FIG. 3, the center of gravity 14 is situated below a first connecting line 17 between the joint center point 15 and a first bearing point 18 on the first lever arm 7. In FIG. 3, the center of gravity 14 is also situated below a second connecting line 19 between the joint center point 15 and a second bearing point 20 on the second lever arm 10. The positional term “below” in FIG. 3 corresponds to a position of the center of gravity 14 of the transverse lever 8 in a position of the piston 4 at top dead center with the highest compression, at which the center of gravity 14 is displaced approximately in a direction toward the rotational axis 22 of the crankshaft 5.

The additional mass 16 is generated for example by means of a partial enlargement of the cross section of the transverse lever 8, which provides a simple and cost-effective solution. A more complex solution would also be possible by screwing on an additional weight.

As a result of the displacement of the center of gravity 14 of the transverse lever 8 on account of the additional mass 16, additional mass forces are generated in the crank drive of the reciprocating-piston internal combustion engine 1 and of the adjusting device 2 during operation of the reciprocating-piston internal combustion engine 1. 1^{st} order mass forces which rotate in the crankshaft rotational direction can be compensated by means of counterweights 21 on the crankshaft 5.

In a single-cylinder power unit designed according to the invention, only 1^{st} order mass forces which rotate counter to the crankshaft 5 remain as low-order mass forces. Said mass forces can be balanced by means of a balancing shaft (not shown).

In a reciprocating-piston internal combustion engine 1 according to the invention having four cylinders 13 in an in-line arrangement with a conventional arrangement of the stroke journal 9 on the crankshaft 5, the remaining 1^{st} order mass forces are balanced out without a balancing shaft on account of the additional mass 16 with the displaced center of gravity 14 on the transverse lever 8. In this way, it is possible to provide a smooth-running reciprocating-piston internal combustion engine 1 of four-cylinder design with an adjusting device 2 for varying the compression ratio. With the design according to the invention, balancing shafts are not needed. Higher-order mass forces are negligibly small in the design according to the invention.

In a reciprocating-piston internal combustion engine having one cylinder 13, the mass distribution of the trans-verse lever 8 is preferably so selected that, depending on the rotating and oscillating mass components of the crank drive which includes the piston 4, the connecting rod 6, the transverse lever 8, the auxiliary connecting rod 11 and the crankshaft 5 the mass forces of the crank drive are reduced to a first order force which rotates counter to the direction of rotation of the crank shaft 5.

In an inline four-cylinder engine 1, the mass distribution of the transverse lever 8 is selected depending on the rotating and oscillating mass components such that the first and second order mass forces and mass moments of the crank drive are virtually completely balanced.

To this end, the distance a between the second bearing point 20 and the first bearing point 18 and the distance b between the second bearing point 20 and the joint center point 15 and the distance c between the first bearing point 18 and the joint center point 15 in relation to the crank radius r are dimensioned such that

4.0r≦a≦7.0r

2.2r≦b≦5.5r, and

1.2r≦c≦3.5r

The advantage of the invention is that with a simple and cost-effective possibility it significantly improves the operating smoothness of a reciprocating-piston internal combustion engine 1 having in particular, four cylinders 13 and an adjusting device 2 for adjusting the compression ratio by attaching an additional mass 16 to the transverse lever 8.

What is claimed is:

1. A reciprocating-piston internal combustion engine (1) having a piston (4) which is movably arranged in a cylinder (13) comprising a connecting rod (6) pivotally connected to the piston (4) and to a stroke journal (9) of a crankshaft (5), so that the movement of the piston (4) can be transmitted to the crankshaft (5), a trans-mission element arranged between the connecting rod (6) and the stroke journal (9), an auxiliary connecting rod (11) for manipulating the movement of said transmission element in order to vary a compression ratio of the reciprocating-piston internal combustion engine (1), said transmission element being a transverse lever (8) which is coupled via a joint at a joint point (15) to the stroke journal (9), which joint is situated in a region between a first bearing point (18) of the transverse lever (8) with respect to the connecting rod (6) and a second bearing point (20) of the transverse lever (8) with respect to the auxiliary connecting rod (11), and the joint between the transverse lever (8) and the stroke journal (9) being arranged in spaced relationship to the connecting line between the two bearing points (18, 20) of the transverse lever (8) with respect to the auxiliary connecting rod (11) and the connecting rod (6), such that in a superposition of the transverse lever (8) on a planar orthogonal axis system with the origin of the axis system at the joint point (15) having a first axis extending through the second bearing point (20) and a second axis perpendicular thereto, with a drawing plane being split up by the two axes into four quadrants I, II, III and IV in the mathematically conventional way, the first bearing point (18) is arranged in the second quadrant II, and a center of gravity (14) of the transverse lever (8) is displaced by an additional mass (16) on the transverse lever (8) in one of the quadrants II, III or IV and the additional mass (16) for displacing the center of gravity (14) of the transverse lever (8) being generated by an enlargement of the transverse lever (8) beyond its dimensions required for its strength.

2. The reciprocating-piston engine as claimed in claim 1, wherein, in a reciprocating-piston engine (1) having one cylinder (13), the mass distribution of the trans-verse lever (8) is selected as a function of rotating and oscillating mass components of the crank drive composed of the piston (4), connecting rod (6), transverse lever (8), auxiliary connecting rod (11) and crankshaft (5) in such a way that the mass forces of the crank drive are reduced to a 1^{st} order force which rotates counter to the rotational direction of the crankshaft (5).

3. The reciprocating-piston engine as claimed in claim 1, wherein, in a reciprocating-piston engine (1) with 4 cylinders (13) in an in-line arrangement, the mass distribution of the transverse lever (8) is selected as a function of rotating and oscillating mass components of the crank drive composed of the piston (4), connecting rod (6), transverse lever (8), auxiliary connecting rod (11) and crankshaft (5) in such a way that the 1^{st} and 2^{nd} order mass forces and mass moments of the crank drive are virtually completely balanced.

4. The reciprocating-piston engine as claimed in claim 1, wherein the distance a between the second bearing point (20) and the first bearing point (18) and the distance b between the second bearing point (20) and the joint centerpoint (15) and the distance c between the first bearing point (18) and the joint center point (15) in relation to the crank radius r are dimensioned as follows:
4.0*r≦a≦7.0*r,
2.2*r≦b≦5.5*r and
1.2*r≦c≦3.5*r.
